(19) United States
(12) Patent Application Publication
(10) Pub. No.: US 2015/0086866 A1
(43) Pub. Date: Mar. 26, 2015

(54) FLOW CONTROLLER OF DRYING OVEN WITH AUTOMATIC AIR CHARGE FOR MANUFACTURING SECONDARY BATTERY

(71) Applicant: LG Chem, Ltd., Seoul (KR)

(72) Inventors: Won Chan Park, Daejeon (KR); Byoung Yook Kang, Seoul (KR); Kyoung Ho Kim, Daejeon (KR); Ye Hoon Im, Daejeon (KR)

(21) Appl. No.: 14/397,414

(22) PCT Filed: May 2, 2013
(86) PCT No.: PCT/KR2013/003784

§ 371 Date: Oct. 27, 2014

(30) Foreign Application Priority Data
May 15, 2012 (KR) 10-2012-0051208

(51) Int. Cl. F26B 21/12; H01M 4/04; H01M 4/64

(52) U.S. Cl. CPC F26B 21/12; H01M 4/64; H01M 4/04
USPC 429/211; 34/565

(57) ABSTRACT

Disclosed herein is an intake air flow control apparatus of an electrode drying oven for manufacturing secondary batteries configured to coat a current collector with an electrode slurry including a solvent and to dry the solvent, the intake air flow control apparatus of the electrode drying oven including at least one electrode drying oven having an intake air duct for supplying external air and an exhaust air duct for discharging a mixed gas containing air and the solvent, a sensor mounted in the exhaust air duct for measuring a concentration of the solvent in the exhaust gas, and a controller for adjusting a supply quantity of air and/or a discharge quantity of gas based on information regarding the concentration of the solvent in the exhaust gas received from the sensor.

### TECHNICAL FIELD

The present invention relates to an intake air flow control apparatus of an electrode drying oven for manufacturing secondary batteries and, more particularly, to an intake air flow control apparatus of an electrode drying oven for manufacturing secondary batteries configured to coat a current collector with an electrode slurry including a solvent and to dry the solvent, the intake air flow control apparatus of the electrode drying oven including at least one electrode drying oven having an intake air duct for supplying external air and an exhaust air duct for discharging a mixed gas containing air and the solvent, a sensor mounted in the exhaust air duct for measuring a concentration of the solvent in the exhaust gas, and a controller for adjusting a supply quantity of air and/or a discharge quantity of gas based on information regarding the concentration of the solvent in the exhaust gas received from the sensor.

### BACKGROUND ART

An important trend in recent development of the electronic industries may be summarized as mobilization of devices and conversion from analog devices to digital devices. Representative examples of the above-mentioned trend may include rapid popularization of wireless phones (also known as mobile phones) and laptop computers and conversion from analog cameras to digital cameras.

In addition to the above-mentioned trend, research and development have been actively conducted into secondary batteries which are used as a power source for devices. Among such secondary batteries is a lithium secondary battery, having a high output and capacity to weight ratio, using a lithium transition metal oxide or a lithium compound oxide as a cathode active material, which is being highly spotlighted. The lithium secondary battery is configured to have a structure in which an electrode assembly of a cathode/separator/anode structure is received in a battery case together with an electrolyte in a sealed state.

Meanwhile, the lithium secondary battery includes a cathode, an anode, and an electrolytic material interposed between the cathode and the anode. Based on what are used as a cathode active material and an anode active material, the lithium secondary battery may be classified as a lithium ion battery (LIB) or a polymer lithium ion battery (PLIB). In general, an electrode plate of the lithium secondary battery is formed by coating a current collector made of an aluminum sheet, a copper sheet, a mesh, a film, or a foil with a cathode or anode active material and then drying the cathode or anode active material coated on the current collector.

A conventional drying system adopts a convection type drying method using hot air.

FIG. 1 is a typical view showing a general structure of the conventional drying system.

Referring to FIG. 1, an electrode drying apparatus for secondary batteries 10 includes an intake air duct 71 and an exhaust air duct 72 extending from a plurality of drying ovens 61, 62, and 63, a plurality of intake air dampers 42, 43, and 44 mounted in the intake air duct 71, a plurality of exhaust air dampers 51, 52, and 53 mounted in the exhaust air duct 72, and a plurality of gas concentration sensors 81, 82, and 83 mounted in the exhaust air duct 72.

Specifically, in the conventional drying system with the above-stated construction, a solvent of an electrode slurry is dried while an electrode with the electrode slurry passes through a drying section, in which the electrode drying ovens 61, 62, and 63 are connected to one another. Each of the electrode drying ovens 61, 62, and 63 has a length of 3 to 6 m. Consequently, the electrode with the electrode slurry passes through the drying section, in which the electrode drying ovens 61, 62, and 63 are connected to one another, having a length of about 30 to 60 m. The electrode drying ovens 61, 62, and 63, the temperatures and outflow speeds in nozzles of which may be independently controlled, are used to provide an optimal drying condition based on a degree of drying as the electrode slurry is dried.

As intake air flow rates 21, 22, and 23 are increased, a gas concentration of an exhaust air is decreased with the result that safety of the electrode drying ovens is increased. However, it is necessary to heat external room-temperature air to a high oven temperature with the result that an energy expense is increased. Furthermore, it is necessary to increase the capacity of a facility for collecting a solvent gas from exhaust air with the result that a facility investment expense is also increased.

In addition, an evaporation quantity of the solvent of the electrode slurry is large at the first half of drying. At the second half of drying, on the other hand, a quantity of a residual solvent is small and, therefore, an evaporation quantity of the solvent of the electrode slurry is decreased.

As a result, evaporation quantities of the solvent of the electrode slurry in the respective drying ovens 61, 62, and 63 are different from one another. For this reason, it is necessary to adjust the intake air flow rates 21, 22, and 23 based on the evaporation quantities of the solvent of the electrode slurry in the respective drying ovens 61, 62, and 63.

To this end, the intake air dampers 42, 43, and 44, which are provided for flow rate adjustment, are mounted in branch intake air ducts diverging from the main intake air duct 71 and connected to the respective drying ovens 61, 62, and 63 and the exhaust air dampers 51, 52, and 53 are mounted in branch exhaust air ducts connected from the respective drying ovens 61, 62, and 63 to the main exhaust air duct 72 such that opening degrees of the intake air dampers 42, 43, and 44 or the exhaust air dampers 51, 52, and 53 are controlled to adjust the intake air flow rates 21, 22, and 23 to the respective drying ovens 61, 62, and 63.

A gas concentration in exhaust air from the respective drying ovens 61, 62, and 63 is frequently changed based on composition, a production speed, etc. of the electrode slurry. However, it is very troublesome to control the opening degrees of the intake air dampers 42, 43, and 44 and, therefore, it is not possible to frequently control the opening degrees of the intake air dampers 42, 43, and 44.

In general, therefore, the intake air flow rates 21, 22, and 23 are adjusted such that a gas concentration remains less than a reference value and a main intake air damper 41 is controlled to set the intake air flow rates such that the maximum value of the gas concentration approximately satisfies the reference value.

In the conventional drying system, therefore, it is necessary for the respective drying ovens to satisfy the reference value of the gas concentration in the exhaust air. As a result, the intake air flow rates are increased more than necessary and, therefore, energy loss due to the increase in temperature of the intake air. Furthermore, it is necessary to increase the capacity of the exhaust gas processing facility.

In addition, a production speed is limited due to the oven having the highest gas concentration in the exhaust air with the result that an overall production speed is lowered.

Since the conventional electrode drying apparatus for secondary batteries have problems in that energy loss is generated due to the increase in temperature of the intake air, it is necessary to increase the capacity of the exhaust gas processing facility, and the production speed is limited due to the oven having the highest gas concentration in the exhaust air with the result that the overall production speed is lowered as described above, there is a high necessity for an intake air flow control apparatus of an electrode drying oven for manufacturing secondary batteries that is capable of optimally and minimally maintaining the intake air flow rates of all of the electrode drying ovens to minimize energy consumption of the electrode drying ovens and to maximize electrode production.

### DISCLOSURE

### Technical Problem

Therefore, the present invention has been made to solve the above problems and other technical problems that have yet to be resolved.

That is, it is an object of the present invention to provide an intake air flow control apparatus of an electrode drying oven for manufacturing secondary batteries configured to automatically adjust intake air ducts and exhaust air ducts of electrode drying ovens based on data measured by gas concentration sensors mounted in the exhaust air ducts of the respective electrode drying ovens so as to supply intake air flow rates to the respective electrode drying ovens such that a concentration of exhaust gases from the respective electrode drying ovens satisfies a reference value, thereby optimally and minimally maintaining the intake air flow rates of all of the electrode drying ovens and, therefore, reducing energy consumption of the electrode drying ovens and improving electrode production.

It is another object of the present invention to provide an electrode for secondary batteries manufactured using the electrode drying apparatus for secondary batteries with the above-stated construction.

### Technical Solution

In accordance with one aspect of the present invention, the above and other objects can be accomplished by the provision of an intake air flow control apparatus of an electrode drying oven for manufacturing secondary batteries configured to coat a current collector with an electrode slurry including a solvent and to dry the solvent, the intake air flow control apparatus of the electrode drying oven including at least one electrode drying oven having an intake air duct for supplying external air and an exhaust air duct for discharging a mixed gas containing air and the solvent, a sensor mounted in the exhaust air duct for measuring a concentration of the solvent in the exhaust gas, and a controller for adjusting a supply quantity of air and/or a discharge quantity of gas based on information regarding the concentration of the solvent in the exhaust gas received from the sensor.

That is, the intake air flow control apparatus of the electrode drying oven for manufacturing secondary batteries according to the present invention is configured to have a structure in which the concentration of the solvent in the exhaust gas is measured, the intake air duct and/or the exhaust air duct are automatically controlled based on information regarding the measured concentration of the solvent in the exhaust gas, thereby supplying an intake air flow rate such that a concentration of exhaust gas satisfies a reference value.

For example, an organic solvent may be used as the solvent. Preferably, N-Methyl-2-pyrrolidone (NMP), which is a combustible organic solvent, is used as the organic solvent.

In a case in which NMP is used as the solvent, external air may be introduced into the electrode drying oven through the intake air duct such that a concentration of the NMP gas in the exhaust gas from the electrode drying oven is maintained at about 25% or less of lower explosive limit (LEL), thereby preventing explosion of the electrode drying oven.

In a concrete example, the at least one electrode drying oven may include two or more electrode drying ovens continuously arranged in a moving direction of an electrode formed by coating the current collector with the electrode slurry.

Specifically, each of the electrode drying ovens may have a length of 3 to 6 m and the electrode drying ovens may be arranged to define a drying section having a total length of 30 to 60 m.

In another concrete example, the intake air flow control apparatus of the electrode drying oven may further include an intake air damper mounted in the intake air duct for adjusting a supply quantity of air and an exhaust air damper mounted in the exhaust air duct for adjusting a discharge quantity of gas.

The intake air damper and the exhaust air damper are not particularly restricted so long as the intake air damper and the exhaust air damper are capable of opening or closing the intake air duct and the exhaust air duct, respectively, or adjusting an intake air flow rate into the electrode drying oven or an exhaust air flow rate from the electrode drying oven. For example, the intake air damper and the exhaust air damper each may be a duct type valve. The duct type valve may be configured to have various forms that are capable of controlling an opening degree of a duct.

The intake air flow control apparatus may control a quantity of air introduced into the electrode drying oven. Specifically, the intake air flow control apparatus may be configured to have a structure for controlling the supply quantity of air such that concentrations of solvents in exhaust gases discharged from two or more electrode drying ovens are the same.

The controller may control the supply quantity of the air and/or the discharge quantity of the gas such that the concentration of the solvent in the exhaust gas discharged from the electrode drying oven is maintained at 25% or less of lower explosive limit (LEL). That is, the controller may be configured to have a structure that is capable of maintaining the concentration of the solvent in the exhaust gas at 25% or less of LEL to prevent explosion of the electrode drying oven due to the exhaust gas containing the high concentration of the solvent and to secure safety of the electrode drying oven.

Consequently, the controller may control the intake air damper and the exhaust air damper to adjust the supply quantity of air such that the explosion of the electrode drying oven is prevented and the intake air flow rate is optimally controlled.

The intake air flow control apparatus of the electrode drying oven may further include damper control units mounted at the intake air damper and the exhaust air damper for controlling opening degrees of the intake air damper and the exhaust air damper according to a control signal from the controller. Consequently, it is possible to adjust the intake air flow rate into the electrode drying oven or the exhaust air flow rate from the electrode drying oven by controlling opening degrees of the intake air damper and the exhaust air damper through the respective damper control units.

For example, each of the damper control units may be a servo motor. The structure of the servo motor is well known in the art to which the present invention pertains and, therefore, a detailed description thereof will be omitted.

In accordance with another aspect of the present invention, there is provided an electrode for secondary batteries manufactured using the intake air flow control apparatus of the electrode drying oven with the above-stated construction.

In accordance with another aspect of the present invention, there is provided a lithium secondary battery including the electrode for secondary batteries as described above. The lithium secondary battery may be a lithium ion battery or a polymer lithium ion battery, which has high energy density, discharge voltage, and output stability.

The lithium secondary battery may be a secondary battery configured to have a structure in which an electrode assembly of a cathode/separator/anode structure is mounted in a battery case in a sealed state in a state in which the electrode assembly is impregnated with an electrolyte. The electrode assembly may be a jelly-roll (wound) type electrode assembly configured to have a structure in which a long sheet type cathode and a long sheet type anode are wound in a state in which a separator is disposed between the cathode and the anode, a stacked type electrode assembly configured to have a structure in which pluralities of cathodes and anodes having a predetermined size are sequentially stacked in a state in which separators are disposed respectively between the cathodes and the anodes, or a stacked/folded type electrode assembly configured to have a structure in which pluralities of cathodes and anodes having a predetermined size are sequentially stacked in a state in which separators are disposed respectively between the cathodes and the anodes to constitute a bi-cell or a full-cell and then a plurality of bi-cells or full-cells is folded using a separation film.

In accordance with another aspect of the present invention, there is provided a battery pack including two or more lithium secondary batteries as unit cells.

For example, the battery pack may be used as a power source of a device selected from among a mobile phone, a laptop computer, a smart phone, a smart pad, a netbook computer, a light electronic vehicle (LEV), an electric vehicle, a hybrid electric vehicle, a plug-in hybrid electric vehicle, and a power storage device. However, the present invention is not limited thereto.

### DESCRIPTION OF DRAWINGS

The above and other objects, features and other advantages of the present invention will be more clearly understood from the following detailed description taken in conjunction with the accompanying drawings, in which:

FIG. 1 is a typical view showing a conventional electrode drying apparatus for secondary batteries; and

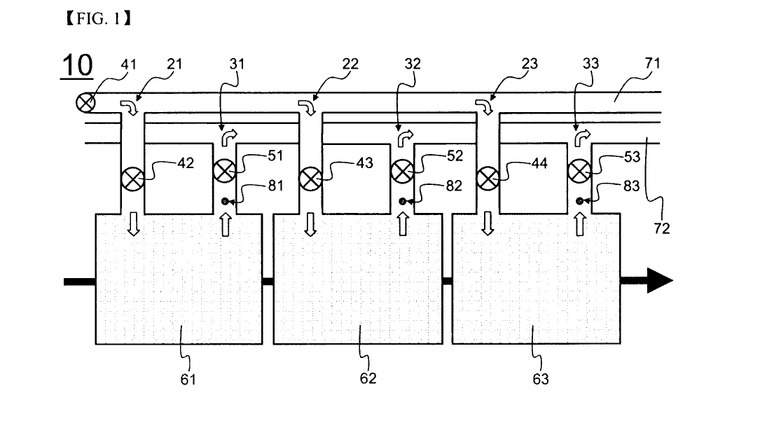

FIG. 2 is a typical view showing an intake air flow control apparatus of an electrode drying oven for secondary batteries according to an embodiment of the present invention.

### BEST MODE

Now, preferred embodiments of the present invention will be described in detail with reference to the accompanying drawings. It should be noted, however, that the scope of the present invention is not limited by the illustrated embodiments.

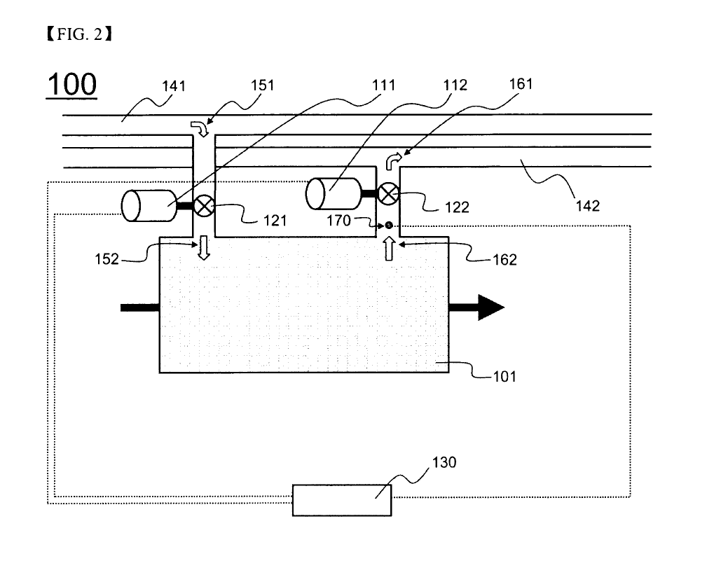

FIG. 2 is a typical view showing an intake air flow control apparatus of an electrode drying oven for secondary batteries according to an embodiment of the present invention.

In FIG. 2, the intake air flow control apparatus of the electrode drying oven for secondary batteries is shown as including one electrode drying oven for the convenience of description. However, the intake air flow control apparatus of the electrode drying oven for secondary batteries may be configured to have a structure in which an electrode is continuously dried while passing through two or more electrode drying ovens.

Referring to FIG. 2, an electrode drying apparatus 100 for manufacturing secondary batteries includes an electrode drying oven 101 having an intake air duct 141 for supplying external air in a moving direction of an electrode formed by coating a current collector with an electrode slurry and an exhaust air duct 142 for discharging a mixed gas containing air and a solvent after the solvent of the electrode slurry is dried. While the electrode with the electrode slurry passes through a drying section defined by the electrode drying oven 101, the solvent of the electrode slurry is dried.

In addition, the electrode drying apparatus 100 further includes an intake air damper 121 mounted in the intake air duct 141 for adjusting a supply quantity of air and an exhaust air damper 122 mounted in the exhaust air duct 142 for adjusting a discharge quantity of gas. Moreover, the electrode drying apparatus 100 further includes a sensor 170 mounted in the exhaust air duct 142 for measuring a concentration of the solvent in the exhaust gas and a controller 130 for controlling at least one of the intake air damper 121 and the exhaust air damper 122 based on information regarding the concentration of the solvent in the exhaust gas received from the sensor 170 to adjust supply quantities 151 and 152 of air and/or discharge quantities 161 and 162 of gas.

The sensor 170 mounted in the exhaust air duct 142 for measuring a concentration of the solvent in the exhaust gas measures a gas concentration based on an evaporation quantity of the solvent in the electrode drying oven 101 and transmits the measured result to the controller 130 an electrical signal. The controller 130 transmits control signals to servo motors 111 and 112 mounted respectively at the intake air damper 121 and the exhaust air damper 122 so as to adjust the supply quantities 151 and 152 of the air and/or the discharge quantities 161 and 162 of the gas such that the concentration of the solvent in the exhaust gas is maintained at 25% or less of lower explosive limit (LEL) based on the electrical signal from the sensor 170.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As is apparent from the above description, an intake air flow control apparatus of an electrode drying oven for manufacturing secondary batteries according to the present invention is configured to supply intake air flow rates to all electrode drying ovens such that a concentration of exhaust gas satisfies a reference value. Consequently, the intake air flow control apparatus of the electrode drying oven for manufacturing secondary batteries according to the present invention has the effect of optimally and minimally maintaining the intake air flow rates of all of the electrode drying ovens, thereby reducing energy consumption of the electrode drying ovens and improving electrode production.

1. An intake air flow control apparatus of an electrode drying oven for manufacturing secondary batteries configured to coat a current collector with an electrode slurry including a solvent and to dry the solvent, the intake air flow control apparatus of the electrode drying oven comprising:
at least one electrode drying oven having an intake air duct for supplying external air and an exhaust air duct for discharging a mixed gas containing air and the solvent;
a sensor mounted in the exhaust air duct for measuring a concentration of the solvent in the exhaust gas; and
a controller for adjusting a supply quantity of air and/or a discharge quantity of gas based on information regarding the concentration of the solvent in the exhaust gas received from the sensor.

2. The intake air flow control apparatus of the electrode drying oven according to claim 1, wherein the solvent is an organic solvent.

3. The intake air flow control apparatus of the electrode drying oven according to claim 2, wherein the organic solvent is N-Methyl-2-pyrrolidone (NMP).

4. The intake air flow control apparatus of the electrode drying oven according to claim 1, wherein the at least one electrode drying oven comprises two or more electrode drying ovens continuously arranged in a moving direction of an electrode formed by coating the current collector with the electrode slurry.

5. The intake air flow control apparatus of the electrode drying oven according to claim 4, wherein each of the electrode drying ovens has a length of 3 to 6 m, and the electrode drying ovens are arranged to define a drying section having a total length of 30 to 60 m.

6. The intake air flow control apparatus of the electrode drying oven according to claim 1, further comprising:
an intake air damper mounted in the intake air duct for adjusting a supply quantity of air; and
an exhaust air damper mounted in the exhaust air duct for adjusting a discharge quantity of gas.

7. The intake air flow control apparatus of the electrode drying oven according to claim 6, wherein the intake air damper and the exhaust air damper each comprises a duct type valve.

8. The intake air flow control apparatus of the electrode drying oven according to claim 6, wherein the intake air damper and the exhaust air damper are controlled by the controller to adjust the supply quantity of air.

9. The intake air flow control apparatus of the electrode drying oven according to claim 8, further comprising damper control units mounted at the intake air damper and the exhaust air damper for controlling opening degrees of the intake air damper and the exhaust air damper according to a control signal from the controller.

10. The intake air flow control apparatus of the electrode drying oven according to claim 9, wherein each of the damper control units is a servo motor.

11. The intake air flow control apparatus of the electrode drying oven according to claim 1, wherein
the at least one electrode drying oven comprises two or more electrode drying ovens, and
the controller controls the supply quantity of air such that concentrations of solvents in exhaust gases from the electrode drying ovens are the same.

12. The intake air flow control apparatus of the electrode drying oven according to claim 1, wherein the controller controls the supply quantity of the air and/or the discharge quantity of the gas such that the concentration of the solvent in the exhaust gas is maintained at 25% or less of lower explosive limit (LEL).

13. An electrode for secondary batteries manufactured using an intake air flow control apparatus of an electrode drying oven according to claim 1.

14. A lithium secondary battery comprising an electrode for secondary batteries according to claim 13.
